(19) United States
(12) Patent Application Publication
(10) Pub. No.: US 2008/0269375 A1
(43) Pub. Date: Oct. 30, 2008

(54) POLYAMIDE RESIN COMPOSITION AND METHOD OF PREPARING SAME

(76) Inventors: Young Mu Park, Namdong-gu (KR); Seok Hwan Kim, Suwon-si (KR); Won Young Choi, Gwangju-si (KR); Seung Don Zu, Nam-gu (KR); Hee Sok Chang, Uijeongbu-si (KR)

Correspondence Address: MORGAN, LEWIS & BOCKIUS LLP (SF), One Market, Spear Street Tower, Suite 2800, San Francisco, CA, 94105, US

(21) Appl. No.: 11/925,524

(22) Filed: Oct. 26, 2007

(30) Foreign Application Priority Data
Dec. 12, 2006 (KR) 10-2006-126629

(51) Int. Cl. C08K 9/00

(52) U.S. Cl. 523/209

(57) ABSTRACT

The present invention relates to a polyamide resin composition and, more particularly, to a polyamide resin composition for an automobile radiator, prepared by mixing a polyamide resin, prepared by mixing a polyamide 66 resin having excellent mechanical strength and heat resistance with a polyamide 612 resin having excellent chemical resistance, a glycidyl reactive compatibilizer, glass fiber coated with a silane-based coupling agent, amine and silane-based crosslinking agents, phenol- and phosphate-based antioxidants, an imide hydrolysis resistance agent, and a montan-based lubricant in a predetermined ratio, thus improving heat resistance and chemical resistance simultaneously and maintaining equivalent properties to those of conventional polyamide resin compositions.

### CROSS-REFERENCE TO RELATED APPLICATION

This application claims the benefit of Korean Patent Application No. 10-2006-126629, filed on Dec. 12, 2006, the content of which is incorporated herein by reference in its entirety.

### BACKGROUND OF THE INVENTION

1. Field of the Invention

The present invention relates to a polyamide resin composition and, more particularly, to a polyamide resin composition suitable for use in automobile parts.

2. Description of Related Art

In general, a polyamide resin composition has excellent mechanical properties, heat resistance and chemical resistance. Having these characteristics, the polyamide resin composition is suitable for reinforcing various inorganic materials such as glass fiber, carbon fiber, talc, kaolin, wollastonite, calcium carbonate, barium sulfate, and the like. Resistance to various chemical materials can be further enhanced with the addition of certain additives. For such reasons, the polyamide resin composition has improved processability and is more light-weight, and can be suited to more versatile designs.

Ordinary polyamide 66 resin is characterized by: high equilibrium moisture absorption, susceptibility to hydrolysis, and low resistance to chlorides, e.g. sodium chloride, calcium chloride, and zinc chloride, which are commonly used as a deicing agent on roads during winter, and to an ethylene glycol solution used as an antifreeze in vehicle engine cooling systems. As the calcium chloride absorbs moisture and dissolves in the melted snow, it forms a calcium chloride solution. Over time, more and more of the solution solidifies and form deposits on the surface of the radiator. The exposure to moisture, heat, and calcium chloride deposits leads to corrosion of the resin surface of the radiator. The breaking of hydrogen bonds between the resin molecules allows the carbonyl groups positioned at the terminal end(s) to react with sodium chloride or potassium chloride ions and ultimately results lowers the cohesiveness of the resin. As this process continues, cracks become more pronounced and the embrittlement more severe until leakage occurs from these cracks. When the above phenomenon occurs in a radiator comprising polyamide resin, it causes the radiator to stall, thereby terminating engine operation. When glycolysis of the antifreeze occurs, the polyamide resin is converted into a primary amine compound and an ester compound having a β-hydroxy ethyl group.

It is well known in the art that ultra-low-molecular-weight substances generated at this time reduce the intermolecular forces between the resin molecules. Accordingly, efforts to develop a polyamide resin or resin composition with improved chemical resistance based on such kinematic analyses and analysis results

The aforementioned efforts led to the development of the invention described in U.S. Pat. No. 4,386,197, which attempted to develop a resin with improved fuel-resistance using caprolactam, ω-aminocarboxylic acid and alicyclic carboxylic acid. However, the resin composition described therein suffers from high processing cost and did not show a remarkable improvement in chemical resistance.

In U.S. Pat. No. 4,582,763, a radiator tank was covered by a cap made of a polyamide resin and an antifreeze was filled therein. Then, an aqueous solution of calcium chloride was coated under a constant temperature and internal pressure to measure cracked-depths and number of cracks after predetermined cycles under constant conditions. However, such a method was not an ideal solution for developing a resin for use in automobile radiators due to the material's poor chemical resistance.

Accordingly, it is necessary to develop a novel resin composition for an automobile radiator that has both excellent heat resistance and resistance to chemicals such as calcium chloride, antifreeze, etc. and has the mechanical properties desired for an automobile radiator.

### SUMMARY OF THE INVENTION

The present invention provides an improved polyamide resin composition and method of preparing same. In one aspect of the invention, the polyamide resin composition is prepared by mixing: a polyamide resin, prepared by mixing a polyamide 66 resin reinforced with glass fiber having excellent heat resistance with a polyamide 612 resin having excellent chemical resistance to the extent that the heat resistance is not lowered; a glycidyl reactive compatibilizer for increasing compatibility; amine and silane-based crosslinking agents; phenol- and phosphate-based antioxidants; an imide hydrolysis resistance agent; and a montan-based lubricant with each other. The polyamide resin, comprising the above-mentioned functional factors, has superior mechanical properties that are well-suited for use in a radiator of a vehicle, e.g. tensile strength, and elongation, due to its lamination, uniform dispersion, superior heat resistance, and resistance against chemicals such as calcium chloride, and antifreeze. This is in part due to the low melting point of the polyamide, which serves as a compatibilizer, and the surface tension resulting therefrom.

### DETAILED DESCRIPTION OF THE INVENTION

The present invention relates to a polyamide resin composition for an automobile radiator comprising: 100 parts by weight of a polyamide resin prepared by mixing a polyamide 66 resin with a polyamide 612 resin in a weight ratio of 65:35 to 75:25; 0.1 to 0.3 parts by weight of a glycidyl reactive compatibilizer; 30 to 35 parts by weight of glass fiber having a particle size of 10 to 12 μm coated with 0.1 to 0.3 weight % of a silane-based coupling agent; 0.1 to 0.3 parts by weight of an amine-based crosslinking agent; 0.01 to 0.1 parts by weight of a silane-based crosslinking agent; 0.3 to 0.5 parts by weight of a phenol-based antioxidant, 0.2 to 0.4 parts by weight of a phosphate-based antioxidant; 0.5 to 1.0 parts by weight of an imide hydrolysis resistance agent; and 0.2 to 0.4 parts by weight of a montan-based lubricant.

Hereinafter, the present invention will be described in more detail.

The polyamide resin for improving chemical resistance has been well known in the art; however, there has not been a composition in which the heat resistance and chemical resistance are simultaneously improved. Accordingly, it is necessary to develop a polyamide resin that has excellent heat resistance and chemical resistance simultaneously and satisfies mechanical properties such as tensile strength, elongation, etc. as a material for an automobile radiator.

The present invention relates to a polyamide resin composition containing a polyamide resin, glass fiber, a compatibilizer and a phenol-based antioxidant and, more particularly, to a polyamide resin composition for an automobile radiator, prepared by mixing: a polyamide resin prepared by mixing a polyamide 66 resin reinforced with glass fiber having excellent heat resistance with a polyamide 612 resin having excellent chemical resistance; a glycidyl reactive compatibilizer for increasing compatibility of the polyamide resin; amine and silane-based crosslinking agents for increasing bonding forces between polymers and between polymer and glass fiber; phenol- and phosphate-based antioxidants; an imide hydrolysis resistance agent; and a montan-based lubricant to provide a microdiffusion effect of humidity resisting and hydrolysis resisting functional factors, thus satisfying mechanical properties such as tensile strength, elongation, etc. and improving chemical resistance such as calcium chloride resistance, antifreeze resistance, etc.

The respective ingredients of the polyamide resin composition for an automobile radiator in accordance with the present invention will now be described in more detail as follows.

The polyamide resin used in the present invention is prepared by mixing a polyamide 66 resin with a polyamide 612 resin having large differences in melting points and flow properties. The reason for this is because the polyamide 612 resin activates the polarities of glycidyl groups and amino groups with strong and long carbon bonds to induce partial crosslinking to a backbone of a polymer matrix material, thus improving thermal and chemical properties of the polyamide 66 resin.

The polyamide 66 resin is prepared by conducting a dehydration polycondensation reaction of hexamethylene diamine with adipic acid, and the polyamide 612 resin is a polyamide resin prepared by copolymerizing hexamethylene diamine with dodecanedioic acid having a long carbon chain. The polyamide 66 resin and the polyamide 612 resin are mixed in a weight ratio of 65:35 to 75:25. If the mixing ratio is less than 65:35, thermal deformation temperature is rapidly lowered and manufacturing cost is increased, whereas, if it exceeds 75:25, a serious deterioration in calcium chloride resistance occurs.

The glycidyl reactive compatibilizer used in the present invention is added to increase the compatibility and is essential in the polyamide resin composition that satisfies the heat resistance and chemical resistance in accordance with the objects of the present invention. The glycidyl reactive compatibilizer is used in a range of 0.1 to 0.3 parts by weight per 100 parts by weight of the polyamide resin. If the content is less than 0.1 parts by weight, heat resistance and diffusion property are lowered, whereas, if it exceeds 0.3 parts by weight, fluidity is remarkably decreased due to excessive crosslinking. The glycidyl reactive compatibilizer can be selected from the group consisting of glycidyl methacrylate, ethyleneglycidyl methacrylate, and mixtures thereof.

The glass fiber used in the present invention has a particle size of 10 to 12 μm. In order to render the glass fiber compatible with the polyamide resin, 0.1 to 0.3 weight % of a silane-based coupling agent is coated thereto. In preferred embodiments, the silane-based coupling agent is an amino silane. If the particle size is less than 10 μm, destruction rate of glass fibers is increased which reduces the mechanical strength of the resulting composition, whereas, if it exceeds 12 μm, orientation of glass fiber becomes more disordered. If the amount of the coated silane-based coupling agent is less than 0.1 weight %, the mechanical strength and chemical resistance are deteriorated, whereas, if it exceeds 0.3 weight %, viscosity is increased to lower workability. The glass fiber is preferably used 30 to 35 parts by weight per 100 parts by weight of the polyamide resin. If the amount of the glass fiber is less than 30 parts by weight, the heat resistance and mechanical strength are decreased, whereas, if it exceeds 35 parts by weight, it is impossible to ensure the processability and appearance quality.

The crosslinking agent used in the present invention includes amine and silane-based crosslinking agents and is added to minimize the amount of the polyamide 612 resin needed. To explain, typically a rather large amount of polyamide 612 is needed to improve resistance against calcium chloride and other salts. The large amount of polyamide 612, however, in turn lowers the heat resistance of the resin. To circumvent this problem, a specific crosslinking agent is used in the present invention to reduce the amount of polyamide 612 needed and yet still achieve good anti-corrosive properties. The crosslinking agent is an amine-based crosslinking agent and a silane-based crosslinking agent. The amine-based crosslinking agent is used in a range of 0.1 to 0.3 parts by weight per 100 parts by weight of the polyamide resin. If the amount thereof is less than 0.1 parts by weight, the heat resistance and chemical resistance do not reach a desired level, whereas, if it exceeds 0.3 parts by weight, it causes a problem in that it is difficult to process due a sharp increase in viscosity. The amine-based crosslinking agent may be at least one selected from the group consisting of ethylene diamine, hexamethylene diamine, triethylene tetramine, and mixtures thereof.

Moreover, the silane-based crosslinking agent is used in a range of 0.01 to 0.1 parts by weight per 100 parts by weight of the polyamide resin. If the amount used is less than 0.01 parts by weight, the chemical resistance does not reach a desired level, whereas, if it exceeds 0.1 parts by weight, it causes a problem in that it is difficult to process due a sharp increase in viscosity. The silane-based crosslinking agent may be at least one selected from the group consisting of epoxysilane, aminosilane, isocyanate silane, and mixtures thereof.

The primary antioxidant used in the present invention is a phenol-based antioxidant that has an improved heat resistance and humidity resistance and additionally a secondary phosphate-based antioxidant is used.

The phenol-based antioxidant is used in a range of 0.3 to 0.5 parts by weight per 100 parts by weight of the polyamide resin. If the amount is less than 0.3 parts by weight, heat aging resistance and humidity resistance are decreased, whereas, if it exceeds 0.5 parts by weight, it causes deterioration in mechanical properties such as tensile strength, bending strength and impact strength as well as the appearance of the resin. As the phenol-based antioxidant, bis-(3,3-bis-(4′-hydroxy-3′-tetrabutylphenol)butanoic acid)-glycol ester having an excellent laminating function is used.

The phosphate-based antioxidant is used in a range of 0.2 to 0.4 parts by weight per 100 parts by weight of the polyamide resin. If the amount is less than 0.2 parts by weight, the heat aging resistance is deteriorated, whereas, if it exceeds 0.4 parts by weight, it causes a deterioration in mechanical properties such as tensile strength, bending strength and impact strength. The phosphate-based antioxidant may be at least one selected from the group consisting of tris-(2,4-di-t-butylphenyl)-phosphate, tetrakis-(2,4-di-t-butylphenyl)-4, 4′-biphenylene diphosphite, and mixtures thereof.

The imide hydrolysis resistance agent used in the present invention is added in a ratio of 0.5 to 1.0 parts by weight per 100 parts by weight of the polyamide resin to inhibit the hydrolysis between polyamide 66 molecules. If the amount is less than 0.5 parts by weight, it is impossible to ensure heat and chemical resistance properties at desired levels, whereas, if it exceeds 1.0 parts by weight, it causes deterioration in mechanical properties such as tensile strength, bending strength and impact strength properties and the processability of the resin. The imide hydrolysis resistance agent may be at least one selected from the group consisting of aromatic polycarbodiimide, aliphatic polycarbodiimide, and mixtures thereof.

The montan-based lubricant used in the present invention is added to improve fluidity and release properties in a ratio of 0.2 to 0.4 parts by weight per 100 parts by weight of the polyamide resin. If the amount is less than 0.2 parts by weight, the release properties and appearance quality are deteriorated, whereas, if it exceeds 0.4 parts by weight, the properties and weld strength are decreased. The montan-based lubricant may be at least one selected from the group consisting of 2-ester montanic acid, 3-ester montanic acid, emulsified ester montanic acid, and mixtures thereof.

The polyamide resin composition is prepared in a reactive extrusion process, in which 100 parts by weight of a polyamide resin mixed with a polyamide 66 resin and a polyamide 612 resin in a weight ratio of 65:35 to 75:25, 0.1 to 0.3 parts by weight of a glycidyl reactive compatibilizer, 30 to 35 parts by weight of glass fiber having a particle size of 10 to 12 μm coated with 0.1 to 0.3 weight % of a silane-based coupling agent, 0.1 to 0.3 parts by weight of an amine-based crosslinking agent, 0.01 to 0.1 parts by weight of a silane-based crosslinking agent, 0.3 to 0.5 parts by weight of a phenol-based antioxidant, 0.2 to 0.4 parts by weight of a phosphate-based antioxidant, 0.5 to 1.0 parts by weight of an imide hydrolysis resistance agent, and 0.2 to 0.4 parts by weight of a montan-based lubricant are fed into a twin-screw extruder to be extruded at a screw rotational speed of 300 to 340 rpm at a temperature of 275 to 295° C. through a melt-kneading process for 15 to 20 minutes. If the reaction temperature is lower than 275° C., it is impossible to ensure the chemical resistance at a desired level and the properties are deteriorated due to an increase in the destruction rate of glass fibers. Whereas, if the reaction temperature is higher than 295° C., it causes a problem in the appearance quality due to degradation and impurities thus formed. Use of a screw rotational speed of less than 300 rpm will increase the reaction, which generate impurities due to degradation, whereas, a speed in excess of 340 rpm shortens the reaction time but results in a considerable deterioration in thermal and mechanical strength and the chemical resistance. Moreover, if the melt-kneading process time is less than 15 minutes, the reaction time is decreased to deteriorate the thermal and mechanical strength and the chemical resistance considerably, whereas, if it exceeds 20 minutes, the reaction time is increased to generate impurities due to degradation.

Hereinafter, the present invention will be described in more detail based on the following Examples; however, they shall not be construed as limiting the scope of the present invention.

### EXAMPLES

### Examples 1 and 2

Descriptions of the components used in the Examples and the Comparative Examples are as follows:

1. Polyamide 66 resin
PA-66: STABAMID® 27A product by Rhodia in France

2. Polyamide 612 resin
PA-612: VESTAMID® D16 product by Degussa AG in Germany

3. Glycidyl compatibilizer
Glycidyl compatibilizer: glycidyl methacrylate

4. Glass fiber
Glass fiber having a particle size of 11 μm and a length of 3.5 mm coated with 0.1 weight % of aminosilane (CS 123D-10P product by Owens Corning Corporation)

5. Crosslinking agents
1) Amine: hexamethylene diamine
2) Silane: beta-(3,4-epoxy cyclohexyl)ethyl ethyltrimethoxy silane

6. Antioxidants
1) Phenol: bis-(3,3-bis-(4′-hydroxy-3′-tetrabutylphenol)butanoic acid)-glycol ester
2) Phosphate: tris-(2,4-di-t-butylphenyl)-phosphate

7. Imide hydrolysis resistance agent
Hydrolysis resistance agent: poly(1,3,5-triisopropyl-phenylene-2,4-carbodiimide)

8. Montan-based lubricant
Lubricant: montan wax fatty acid ethylene ester

A polyamide resin composition was prepared by feeding the polyamide 66 resin, polyamide 612 resin, glycidyl reactive compatibilizer, glass fiber, amine-based crosslinking agent, silane-based crosslinking agent, phenol-based antioxidant, phosphate-based antioxidant, imide hydrolysis resistance agent, and montan-based lubricant, shown in the following table 1, into a twin-screw extruder (L/D: 40 and D: 80 Ø) to be mixed with each other.

### Comparative Examples 1 to 4

A composition was prepared in the same manner as Example 1 while changing the ingredients as shown in the following table 1.

### Comparative Examples 5

A composition was prepared in the same manner as Example 1 while changing the screw rotational speed to 400 rpm.

TABLE 1

| Classification | | Example | | Comparative Example | | | | |
|---|---|---|---|---|---|---|---|---|
| (Parts by weight) | | 1 | 2 | 1 | 2 | 3 | 4 | 5 |
| Polyamide | PA-66 | 65 | 75 | 100 | 50 | 65 | 65 | 65 |
| Resin | PA-612 | 35 | 25 | — | 50 | 35 | 35 | 35 |
| Glass fiber | | 33 | 33 | 33 | 33 | 36 | 33 | 33 |
| Glycidyl compatabilizer | | 0.1 | 0.3 | 0.1 | 0.1 | 0.1 | 0.1 | 0.1 |
| Crosslinking | Amine | 0.1 | 0.3 | 0.1 | 0.1 | 0.1 | 0.1 | 0.1 |
| Agent | Silane | 0.01 | 0.1 | 0.01 | 0.01 | 0.01 | 0.01 | 0.01 |
| Antioxidant | Phenol | 0.3 | 0.5 | 0.3 | 0.3 | 0.3 | 0.3 | 0.3 |
| | Phosphate | 0.2 | 0.4 | 0.2 | 0.2 | 0.2 | 0.2 | 0.2 |

| | | | | | | | |
|---|---|---|---|---|---|---|---|
| Hydrolysis resistance agent | 0.5 | 1.0 | 0.5 | 0.5 | 0.5 | — | 0.5 |
| Lubricant | 0.2 | 0.4 | 0.2 | 0.2 | 0.2 | 0.2 | 0.2 |
| Screw rpm | 340 | 340 | 340 | 340 | 340 | 340 | 400 |

### Experimental Example

Properties of compositions prepared in Example 1 and 2, Comparative Examples 1 to 5 were measured and the results are shown in the following table 2.

Method of Measuring Properties

1. Calcium chloride resistant-flexural strength retention rate

Test pieces of 10×100×3.2 mm prepared by cutting a sample of FMVSS (Federal Motor Vehicle Safety Standard) with the dimension of 100×350×3.2 mm in a 20% calcium chloride solution at a temperature of 120° C. for 140 hours and then flexural strength retention rates were measured. To note, flexural strength retention rate exceeding about 47% is considered superior by industry standards.

2. Antifreeze resistant-tensile strength embrittlement rate

Tensile strength test pieces for ASTM D638 (dog-bone type) were immersed tightly in a 50% aqueous solution of an antifreeze at 146° C. for 144 hours and then tensile strength embrittlement rates were measured. Embrittlement rate should be less than 70% and embrittlement strength be more than 350 kg/cm² according to the evaluation standards.

3. Jig test of calcium chloride resistance

After immersing test pieces (50×80×3.2 mm, central portion: 25×80×1.6 mm) in a 20% calcium chloride solution at 80° C. for 15 hours, the solution was applied to the resulting test pieces at room temperature for 2 hours and then placed into an oven at 100° C. for 2 hours, which thus became one cycle for 4 hours in total. The central portions of the test pieces were pushed up by 1 mm by the operation of the jig to observe whether or not cracks were generated at every cycle. The observation was performed for 12 cycles in total. If cracks were found in the central portion of the test piece within 7 cycles, the resistance was evaluated as unsuitable and the final evaluations were performed after 12 cycles.

4. Reliability evaluation of calcium chloride resistance

1) Reliability evaluation 1: A 20% calcium chloride solution was sprayed to radiator tanks formed of the compositions of Examples 1 and 2 and Comparative Examples 1 to 5 in a test chamber for calcium chloride resistance at room temperature (25° C.) and left to stand for 1 hour. Subsequently, the resulting radiator tanks were degraded in an oven at 120° C. for 2 hours by applying circulation pressure (1.1 kg/cm²) of an antifreeze, which thus became one cycle for 3 hours in total. The cycle was performed repeatedly in such a manner that the pressure was removed when the radiator tank under the testing procedure was taken out of the oven and then the pressure was reapplied before the radiator tank was put into the oven. During the evaluation process, if water or pressure leaked due to cracks, the test for the corresponding radiator tank was stopped, and if passed more than 40 cycles, the radiator tanks were evaluated as suitable.

Reliability evaluation 2: Performed in the same manner as reliability evaluation 1 while the pressurizing process was fixed and the humidity in the test chamber was 50 to 60%.

5. Heat resistance: Performed in accordance with ASTM D-648. Reference value should be higher than 235° C.

6. Tensile strength: Performed in accordance with ASTM D-638. Reference value should be more than 1,600 kg/cm².

7. Elongation: Performed in accordance with ASTM D-638. Reference value should be more than 3%.

8. Flexural strength: Performed in accordance with ASTM D-790. Reference value should be more than 2,100 kg/cm².

9. Flexural modulus: Performed in accordance with ASTM D-790. Reference value should be more than 65,000 kg/cm².

10. Izod impact strength: Performed in accordance with ASTM D-256.

Reference value should be more than 9 kg/cm².

TABLE 2

| | Example | | Comparative Example | | | | |
|---|---|---|---|---|---|---|---|
| Classification | 1 | 2 | 1 | 2 | 3 | 4 | 5 |
| Clacium shloride resistant- | 53 | 49 | 34 | 64 | 52 | 46 | 42 |
| flexural strength retention | | | | | | | |
| rate (%) | | | | | | | |
| Antifreeze resistant-tensile | 64 | 68 | 78 | 60 | 63 | 71 | 73 |
| strength embrittlement rate | 592 | 576 | 367 | 640 | 581 | 423 | 367 |
| [embrittlement rate (%), | | | | | | | |
| embrittlement strength | | | | | | | |
| (kg/cm²)] | | | | | | | |
| Jig test of calcium chloride | No | No | Cracks | No | No | Cracks | Cracks |
| resistance | | (whiten- | | | | | |
| (cracks generated) | | ing) | | | | | |
| Reliability evaluation of | Suitable | Suitable | Unsuitable | Suitable | Suitable | Unsuitable | Unsuitable |
| calcium chloride resistance | | | | | | | |
| 1 | | | | | | | |
| Reliability evaluation of | Suitable | Suitable | Unsuitable | Suitable | Suitable | Unsuitable | Unsuitable |
| calcium chloride resistance | | | | | | | |
| 2 | | | | | | | |
| Heat resistance (° C.) | 239 | 253 | 256 | 214 | 242 | 238 | 251 |
| Tensile strength (kg/cm²) | 1842 | 1780 | 1920 | 1800 | 1878 | 1775 | 1754 |
| Elongation (%) | 3.2 | 4.0 | 4.5 | 4.1 | 3.6 | 3.8 | 3.5 |
| Flexural strength (kg/cm²) | 2510 | 2350 | 2470 | 2345 | 2515 | 2340 | 2310 |
| Flexural modulus (kg/cm²) | 87600 | 80100 | 85700 | 79650 | 88800 | 77540 | 77350 |
| Impact strength (kg/cm²) | 14.5 | 11.3 | 9.5 | 10.5 | 15.2 | 10.1 | 10.2 |

According to the test results shown in table 2, it was ascertained that the polyamide resin compositions of Examples 1 and 2 had excellent chemical resistance compared with those of Comparative Examples, thermal and mechanical strength commensurate with those of the conventional art, and excellent calcium chloride resistance, antifreeze resistance, heat resistance, and the like. Moreover, the mechanical properties such as tensile strength, elongation, etc. were slightly decreased in the polyamide resin compositions of Examples 1 and 2 compared with those of Comparative Examples; however, the polyamide resin compositions of Examples 1 and 2 passed the reference values as a material for an automobile radiator and had heat resistance and chemical resistance simultaneously. Comparative Example 1 had a problem in that the chemical resistance was remarkably decreased, Comparative Example 2 showed a defect in that the heat resistance was rapidly lowered, and Comparative Example 3 had drawbacks in that the workability was lowered and the appearance quality was unsuitable. Furthermore, Comparative Example 4 showed a problem in that only the chemical resistance was somewhat improved compared with that of Comparative Example 1, and Comparative Example 5 had drawbacks in that the chemical resistance and mechanical strength were considerably lowered.

As described in detail above, the polyamide resin composition for an automobile radiator in accordance with the present invention demonstrate both excellent heat resistance and chemical resistance as compared with the conventional composition and satisfies mechanical properties such as tensile strength, elongation, etc. as a material for an automobile radiator. Accordingly, the polyamide resin composition of the invention can be applied to a radiator tank used in an automobile, thus contributing to improved overall vehicle performance.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A polyamide resin composition comprising:
a) 100 parts by weight of a polyamide resin having a polyamide 66 resin and a polyamide 612 resin in a weight ratio of 65:35 to 75:25;
b) 0.1 to 0.3 parts by weight of a glycidyl reactive compatibilizer;
c) 30 to 35 parts by weight of glass fiber having a particle size of 10 μm to 12 μm coated with 0.1 to 0.3 wt % of a silane-based coupling agent;
c) 0.1 to 0.3 parts by weight of an amine-based crosslinking agent;
d) 0.01 to 0.1 parts by weight of a silane-based crosslinking agent;
e) 0.3 to 0.5 parts by weight of a phenol-based antioxidant;
f) 0.2 to 0.4 parts by weight of a phosphate-based antioxidant;
g) 0.5 to 1.0 parts by weight of an imide hydrolysis resistance agent; and
h) 0.2 to 0.4 parts by weight of a montan-based lubricant.

2. The polyamide resin composition of claim 1,
wherein said glycidyl reactive compatibilizer comprises at least one selected from the group consisting of glycidyl methacrylate, ethyleneglycidyl methacrylate, and mixtures thereof.

3. The polyamide resin composition of claim 1,
wherein said amine-based crosslinking agent comprises at least one selected from the group consisting of ethylene diamine, hexamethylene diamine, triethylene tetramine, and mixtures thereof.

4. The polyamide resin composition of claim 1,
wherein said silane-based crosslinking agent comprises at least one selected from the group consisting of epoxysilane, aminosilane, isocyanate silane, and mixtures thereof.

5. The polyamide resin composition of claim 1,
wherein said phenol-based antioxidant is a bis-(3,3-bis-(4′-hydroxy-3′-tetrabutylphenol)butanoic acid)-glycol ester.

6. The polyamide resin composition of claim 1,
wherein said phosphate-based antioxidant comprises at least one selected from the group consisting of tris-(2,4-di-t-butylphenyl)-phosphate, tetrakis-(2,4-di-t-butylphenyl)-4, 4′-biphenylene diphosphite, and mixtures thereof.

7. The polyamide resin composition of claim 1,
wherein said imide hydrolysis resistance agent comprises at least one selected from the group consisting of aromatic polycarbodiimide, aliphatic polycarbodiimide, and mixtures thereof.

8. The polyamide resin composition of claim 1,
wherein said montan-based lubricant comprises at least one selected from the group consisting of 2-ester montanic acid, 3-ester montanic acid, emulsified ester montanic acid, and mixtures thereof.

9. A method for preparing a polyamide resin composition,
wherein a) 100 parts by weight of a polyamide resin having a polyamide 66 resin and a polyamide 612 resin in a weight ratio of 65:35 to 75:25; b) 0.1 to 0.3 parts by weight of a glycidyl reactive compatibilizer; c) 30 to 35 parts by weight of glass fiber having a particle size of 10 to 12 μm coated with 0.1 to 0.3 weight % of a silane-based coupling agent; d) 0.1 to 0.3 parts by weight of an amine-based crosslinking agent; e) 0.01 to 0.1 parts by weight of a silane-based crosslinking agent; f) 0.3 to 0.5 parts by weight of a phenol-based antioxidant; g) 0.2 to 0.4 parts by weight of a phosphate-based antioxidant; h) 0.5 to 1.0 parts by weight of an imide hydrolysis resistance agent; and i) 0.2 to 0.4 parts by weight of a montan-based lubricant into a twin-screw extruder are fed into a twin-screw extruder and extruded at a screw rotational speed of 300 to 340 rpm at a temperature of about 275° C. to about 295° C. through a melt-kneading process for 15 to 20 minutes, thus preparing the polyamide resin composition.

10. An automobile radiator tank prepared by molding a composition of claim 1.
